(19) United States
(12) Patent Application Publication
(10) Pub. No.: US 2025/0342710 A1
(43) Pub. Date: Nov. 6, 2025

(54) GENERATION OF TRAINING IMAGES MIMICKING HANDWRITTEN TEXT INCLUDING NON-ALPHANUMERIC CHARACTERS FOR TRAINING OPTICAL CHARACTER RECOGNITION (OCR) MACHINE LEARNING MODELS

(71) Applicant: OPEN TEXT INC., Wilmington, DE (US)

(72) Inventors: Jaya Lakshmi Navya Yadlapalli, Hyderabad (IN); Divya Minikar, Hyderabad (IN)

(73) Assignee: OPEN TEXT INC., Wilmington, DE (US)

(21) Appl. No.: 19/265,785

(22) Filed: Jul. 10, 2025

Related U.S. Application Data
(63) Continuation-in-part of application No. 18/476,881, filed on Sep. 28, 2023.

(51) Int. Cl. G06V 30/19; G06T 11/20

(52) U.S. Cl. CPC G06V 30/19167; G06T 11/203

(57) ABSTRACT

Training images mimicking handwritten text including one or more non-alphanumeric characters are used at least for training an optical character recognition (OCR) machine learning model. The train images are generated as follows. A character sequence format and the non-alphanumeric characters are specified. Character sequences in the specified character sequence format with the specified non-alphanumeric characters are generated using a regular expression pattern for the specified character sequence format. Synthetic handwritten images are generated for each character sequence. A handwritten text image-generating machine learning model for generating the training images is trained using at least the generated synthetic handwritten images. The training images mimicking the handwritten text including the non-alphanumeric characters are generated using the trained handwritten text image-generating machine learning model.

### RELATED APPLICATIONS

The present patent application is a continuation-in-part of the pending patent application having Ser. No. 18/476,881 and filed on Sep. 28, 2023, which is hereby incorporated by reference.

### BACKGROUND

Text is frequently electronically received in a non-textually editable form. For instance, data representing an image of text may be received. The data may have been generated by scanning a hardcopy of the image using a scanning device, by capturing the image using a smartphone or other computing device having a camera or other type of image-capturing sensor, or in another manner. The text is not textually editable, because the data represents an image of the text as opposed to representing the text itself in a textually editable and non-image form and thus cannot be edited using a word processing computer program, a text editing computer program, and so on. To convert the data to a textually editable and non-image form, optical character recognition (OCR) may be performed on the image to generate data representing the text in a textually editable and non-image form, so that the data can be edited using a word processing computer program, a text editing computer program, and so on.

### BRIEF DESCRIPTION OF THE DRAWINGS

FIG. 1 is a flowchart of an example method for generating training images mimicking handwritten text including non-alphanumeric characters, for training an optical character recognition (OCR) machine learning model.

FIG. 2A is a diagram of six example synthetic handwritten images including non-alphanumeric characters that can be generated during performance of the method of FIG. 1, but which are not the OCR machine learning model training images that ultimately are generated in the method.

FIG. 2B is a diagram of four example OCR machine learning model training images that ultimately are generated in the method of FIG. 1 for training an OCR machine learning model.

FIG. 3 is a diagram of an example environment in which a system for generating training images for an OCR machine learning model can generate the training images and transmit them to a system for training (and using) the OCR machine learning model.

FIGS. 4A, 4B, and 4C are flowcharts of an example method for generating training images mimicking handwriting text including non-alphanumeric characters and for training and using an OCR machine learning model within the environment of FIG. 3.

FIG. 5 is a diagram of an example computing system.

### DETAILED DESCRIPTION

As noted in the background section, data can represent an image of text, as opposed to representing the text itself in a textually editable and searchable non-image form that can be edited using a word processing computer program, a text editing computer program, and so on. To convert the data to a textually editable and searchable non-image form, optical character recognition (OCR) may be performed on the image. Performing OCR on the image generates data representing the text in a non-image form, so that the data can be edited using a computer program like a word processing computer program or a text editing computer program, for instance.

A machine learning model may be used to perform OCR on an image of text to convert the data into a textually editable and searchable non-image form. The machine learning model may be a supervised machine learning model, which means that the machine learning model first has to be trained before the model can actually perform OCR. Such a machine learning model is trained on large amounts of training data in the form of images of text that are labeled. That is, the training data includes a large number of images of text, where each image is accompanied by the word or words that appear in the image.

Although such OCR machine learning models may on average have good accuracy, their accuracy may suffer for certain types of images of text. For example, an OCR machine learning model may have been trained on scanned images of printed documents that were computer-generated, such as scanned images of word processing documents printed on white office paper, and so on. Such an OCR machine learning model will likely have reduced accuracy for images of text handwritten on ruled notepad paper, particularly when such handwritten text is in cursive form as opposed to in block letter form. The failure of an OCR machine learning model to recognize handwritten text can become an issue when the model is primarily used for this purpose.

One way to improve the accuracy of an OCR machine learning model for handwritten text is therefore to train the model using training images of handwritten text. However, readily available corpuses of OCR training data do not include large numbers of training images of handwritten text that include non-alphanumeric characters, such as !″#$%&\′()*+,−./:;<=>?@[\\]^{∧}_‘{|}˜. An OCR machine learning model trained using existing datasets of handwritten text images may on average have good accuracy, but its accuracy is likely to suffer with images having relatively large proportions of non-alphanumeric characters. This can be an issue in images including large numbers of email addresses, currency amounts, dates, and so on, limiting the usefulness of the model.

Improving the accuracy of an OCR machine learning model for handwritten text is more desirable than instead, for instance, requiring users to change how they provide information on forms. That is, users often fill out forms in a handwritten manner. Requiring them to instead of using a computer to fill out the forms so that the information is more easily digested can be onerous. Users, in other words, should continue to be able to handwrite information on forms, with OCR machine learning models having their accuracy improved instead.

Techniques described herein ameliorate these and other issues. The techniques provide a way to generate OCR machine learning model training images that mimic handwritten text including non-alphanumeric characters. Furthermore, the training images can be generated for specified character sequence formats, such as email addresses, different currency formats, date formats, and so on, examples of which are described below. The OCR machine learning model will therefore likely have improved accuracy for images of actual handwritten text with non-alphanumeric characters in the specified character sequence formats.

The techniques described herein can further generate training images so that they correspond to the images of handwritten text on which the OCR machine learning model is expected to be used. For example, if the model is anticipated to be used on images of text specifically handwritten on ruled notepad paper, the training images can be generated to approximate or simulate handwritten text against a background of ruled notepad paper. The machine model will therefore likely have improved accuracy, since the model will have been trained on the same types of images.

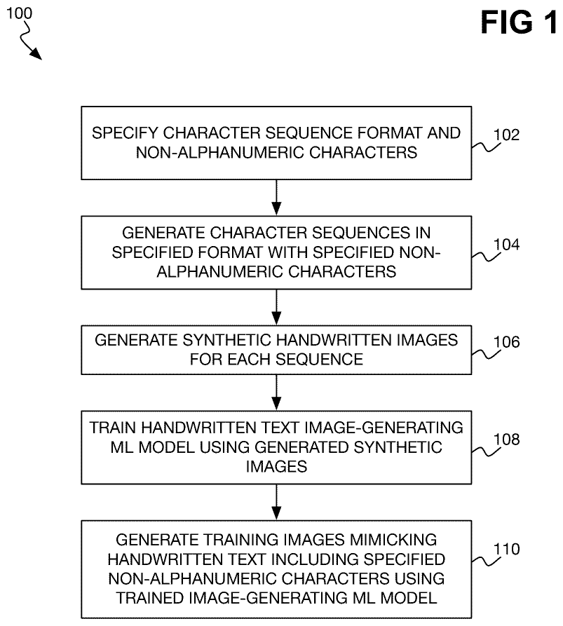

FIG. 1 shows an example method 100 for generating domain-specific images that can be used for training and/or validation of an OCR machine learning model. The method 100 can be implemented as program code stored on a non-transitory computer-readable data storage medium and executed by a processor of a computing device to perform processing. The data storage medium may be a volatile storage medium such as a semiconductor medium like a dynamic random-access memory (DRAM), or may be a non-volatile storage medium such as a solid-state drive (SSD), a flash memory, a hard-disk drive (HDD), and so on.

The method 100 includes specifying a character sequence format for which training images mimicking handwritten text are to be formatted, as well as specifying non-alphanumeric characters that the text in the specified format are to include (102). That the training images “mimic” handwritten text means that the training images realistically approximate what human users would handwrite themselves. That is, the training images realistically emulate or simulate handwritten text, but are generated and not actually handwritten by human users.

Non-alphanumeric characters are characters other than letters (e.g., characters other than a, b, c, d, A, B, C, D, and so on) and numbers (e.g., 0, 1, 2, 3, 4, and so on). Non-alphanumeric characters may also be referred to in some cases as special characters or symbols. As noted above, example non-alphanumeric characters include !″#$%&\′()*+,−./:;<=>?@[\\]¹⁵⁸ _‘{|}˜.

A character sequence format is the format in which sequences of characters are to appear in the handwritten text that generated training images are to mimic. Stated in another way, a character sequence format can be considered how sequences of characters, including both alphanumeric and non-alphanumeric characters, letters, numbers, symbols, etc.) are arranged or structured. Character sequence formats can include email formats, currency formats, date formats, and number formats, among others.

An email address format specifies the format in which email addresses are arranged. Email address can most generally have to be formatted with a local part and a domain part separate by @, with particular rules governing which characters can be included in each part. The domain part includes a suffix having one or more periods or dots, such as “.com”, “.edu”, “.co.uk” and so on). The email address format specified in 102 may therefore dictate email addresses having particularly arranged local parts with particular domain parts. For example, the local parts may have to consist of two sequences of only alphanumeric letters separated by a period or dot, such as “first.last”. The domain parts may have to be selected from a group of specified domain parts, such as “name.com”, “differentname.org”, and so on.

A currency format can specify the desired currency symbols (e.g., $, €, £, and so on), as well as the number format in which current amounts are to be expressed. A number format can therefore be part of a currency format, or be used by itself. A number format can specify how large the amounts are to be (i.e., the number of digits). A number format can specify whether the amounts include whole amounts or decimal amounts, and the precision of the amounts in the case of decimal amounts (e.g., 4.95 as compared to 5 as compared to 4.949, and so on).

A number format can further specify how digits are to be grouped (e.g., using commas to separate groups of three digits, such as 1,293,892), as well as whether a comma or a period is used to indicate the decimal point (e.g., 4,95 as opposed to 4.95). A number format may also specify that ordinal indicators are to be used. As examples, instead of specifying the numbers as 1 and 23 as such, the format may specify them as 1st and 23rd, where “st” and “rd” are the ordinal indicators in these examples.

A date format specifies calendar dates, including which two or three of day, month, and year the dates should have, the order in which they are listed, how each is itself formatted, and which characters are used to separate them from one another. For example, the month may be expressed numerically or by using letters. In the former case, the month may be expressed by the minimum number of digits (e.g., 1 for January and 10 for October) or by two digits (e.g., 01 for January). In the latter case, the month may be expressed by its complete name (e.g., January or October) or using just one, two, or three letters (e.g., Ja or Jan for January, Jn or Jun for June, and so on).

Like the month, the day may be expressed numerically or using letters, where in the former case whether the minimum number of digits or two digits are used is also specified. The year may be expressed using two or four digits (e.g., 2025 or just 25), or even spelled out (e.g., “twenty twenty-five” or “two-thousand, two hundred, and twenty-five”). The day of the week may also be included in a date format, including how it is to be formatted (e.g., Monday versus M or Mon) and ordered in relation to the day, month, and/or year.

Two example date formats are described for the sake of concreteness. The first is MM-DD-YY, where MM represents that the month is always expressed by two digits, DD represents that the day is always expressed by two digits, and YY represents that the year is always expressed by two digits, and where the month, day, and year are separated by a dash. The second format is Month D, YYYY, where Month denotes that the name of the month is to be spelled out completely (e.g., January and not 1, 01, or Jan), the day is to be specified using the minimum number of digits possible (e.g., 7 as opposed to 07), and the year is to be specified using four digits (e.g., 2025 as opposed to 25). In this example format, the month and the day are separated by a space, and the day and the year are separated by a comma followed by a space.

The method 100 includes generating character sequences in the specified format with the specified non-alphanumeric characters (104). For example, if the specified character format is the date format “DD-MM-YYYY”, example character sequences include Jul. 1, 1970 (for Jan. 7, 1970), 18-10-2025 (for Oct. 18, 2025), and so on. In one implementation, the character sequence format can be expressed as a regular expression pattern, and a regular expression sample generator—which may also be referred to as a reverse regular expression generator—uses this pattern to generate the character sequences.

A regular expression pattern, which may also be referred as simply a regular expression, regex or regexp, is a sequence of characters that specifies a match pattern in text. Different syntaxes for writing regular expression includes the POSIX standard and the Perl syntax. The regular expression for the date format “DD-MM-YYYY”, for instance, can be “^{∧}(0[1-9][12][0-9]|3[01])-(0[1-9]|1[0-2])-(\d {4})$”. In this example, the non-alphanumeric character is the dash.

Note that the above regular expression may not be valid for every month. As one example, February 31, 2025, satisfies this regular expression, but of course February 31, 2025 is not a valid date. A more complex regular expression for the date format in question can thus be “^{∧}(?:(?:31-(?:0[13578]|1[02]))| #31st is valid for Jan, Mar, May, Jul, Aug, Oct, Dec (?:30-(?:0[1-9]|1[0-2]))| #30th is valid for all months except Feb (?:0[1-9]|1\d|2[0-8])-(?:0[1-9]|1[0-2])| #01-28 is valid for all months (?:29-02-(?:\d{2}(?:0[48]|[2468][048]|[13579][26])| #29th Feb valid in leap years (?:00|[02468][048]|[13579][26])00)))$ # Century leap years (e.g., 1600, 2000).

A regular expression generator may be implemented as an online tool by which a regular expression pattern is provided, and matching character sequences are returned. A regular expression generator may be a code library (which the online tool may itself use). Example such code libraries include the JavaScript library randexp.js, the Python library rstr, the Java library Generex, and so on. A regular expression generator generates character sequences matching a specified regular expression using an algorithm.

The method 100 includes generating synthetic handwritten images for each character sequence that is generated (106). This means, for instance, that if there are X character sequences, and if Y character synthetic handwritten images are to be generated for each character sequence, then X*Y synthetic handwritten images are generated. More generally, however, X*Y synthetic images are not mandatory, but rather the number of generated synthetic images can depend on the number that a user has defined as sufficient for the model in question.

A synthetic handwritten image of a character sequence is an image in which the characters of the sequence are reproduced using a computer font that is intended to correspond to handwriting. Example such fonts include Comic Sans, Bradley Hand, Lucida Handwriting, Segoe Script, Caveat, Patrick Hand, Dancing Script, Homemade Apple, Indie Flower, Amatic SC, and Shadows Into Light, among others. Stated more generally, the fonts are those that are similar to handwriting, including cursive handwriting.

The handwritten images of a character sequence are thus synthetic in the sense that each character in the sequence is rendered using a computer font. Furthermore, in addition to font type (i.e., the name of the font), there may be other font rendering parameters as well as non-font rendering parameters that control image generation. Other font rendering parameters include font style (e.g., underlining, bold, italics, and so on, as well as regular, which is text in the font that is not underlined, bold, italicized, and so on) as well as font size (e.g., 8 point, 10 point, 12 point, and so on). Non-font parameters include background and filter parameters, the former specifying or more image backgrounds and latter specifying one or more filters.

For each character sequence, a synthetic handwritten image corresponding to each unique combination of one of the specified fonts, one of the image backgrounds, and one of the filters is generated. For example, the font parameter may specify two different handwriting-oriented fonts, in three font styles (plain, bold, and italicized), and in three font sizes (8, 12, and 24-point). There are therefore 2×3×3−18 different font-style-size combinations. The background parameter may specify two image backgrounds: a plain white image and a ruled notebook image. The filter parameter may specify two filters: no filter and a blur filter that when applied blurs an image. In this example, there are therefore 18×2×2=72 different font-background-filter combinations, such that 72 different images are generated for each domain-relevant word; that is, 72 different images are generated for each specified (handwritten) font, of which there are 18.

It is noted that the image backgrounds can include other types of backgrounds than the two listed in the previous paragraph. For example, the image backgrounds can include backgrounds that simulate or emulate poor background noise—i.e., such that the resulting images mimic low quality images that result from poor scanning, as may be the case with “scanning” by capturing an image using a mobile device such as a smart phone or by scanning at a low resolution or with a dirty scanning device or poor-quality scanning device.

The method 100 includes training a handwritten text image-generating machine learning model using the generated synthetic handwritten images (108). The synthetic handwritten images that are generated are not to be confused with the training images that are ultimately generated for training an OCR machine learning model. Furthermore, the text image-generating machine learning model that is trained using synthetic images is not to be confused with the OCR machine learning model itself. They are different models.

The handwritten text image-generating machine learning model is a machine learning model that generates handwritten images that more closely approximate actual handwriting than simply using computer fonts that corresponding to handwriting to reproduce the characters as above. Depending on the text image-generating machine learning model that is used, the model may be trained in a supervised or an unsupervised manner, or even in a partially supervised (i.e., semi-supervised) manner.

In unsupervised training, the model is trained using synthetic handwritten images without a ground truth file specifying the particular character sequence in each image (i.e., without labeled data). By comparison, in supervised training, the model is trained using synthetic handwritten images along with a ground truth file specifying the particular character sequence in each image. In this case, therefore, a ground truth file is generated when synthetic handwritten images are generated. In partially supervised training, the model is trained using a small amount of labeled data and a large amount of unlabeled data.

One example of a handwritten text image-generating machine learning model is the ScrabbleGAN model, which is trained in a semi-supervised or unsupervised manner. This model is described in Sharon Fogel et al., “ScrabbleGAN: Semi-Supervised Varying Length Handwritten Text Generation,” arXiv:2003.10557 (2003). The ScrabbleGAN model is a type of Generative Adversarial Network (GAN) machine learning model, which may be trained in an unsupervised manner depending on the model. Other types of GAN models can also be used as the handwritten text image-generating machine learning model.

Another type of machine learning model that can be used as the handwritten text image-generating model is a model that uses a Transformer as a neural network architecture. Depending on the model, it may be trained in a supervised, unsupervised, or partially supervised manner. Furthermore, a Transformer-based GAN—which is a hybrid machine learning model—may also be used. Other types of machine learning models may be used as the handwritten text image-generating model as well.

The method 100 includes generating training images mimicking handwritten text including the specified non-alphanumeric characters in the specified character sequence format using the trained model (110). These generated images can then be used for training an OCR machine learning model to more accurately recognize captured or scanned images or documents of actual such handwritten text.

The training images may be generated using the handwritten text image-generating machine learning model by simply running the model after it has been trained. Depending on the specific model that was trained, parameters may also be specified to control generation of the training images. For example, the character sequences used to generate the synthetic handwritten images may be provided as input to generate the training images, as well as other parameters including, for example, any special (non-alphanumeric) characters or symbols that are likely to be encountered.

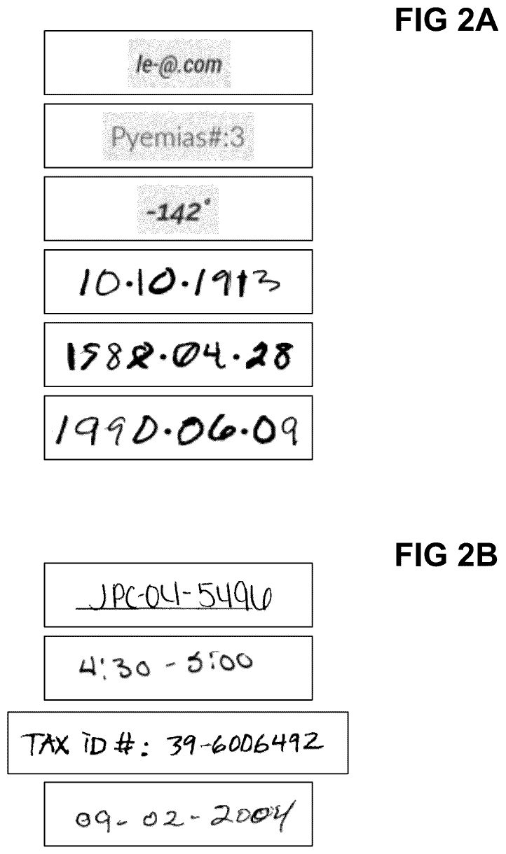

FIG. 2A is a diagram of six example synthetic handwritten images including non-alphanumeric characters that can be generated in 106 of the method 100 of FIG. 1 for machine learning model training in 108. FIG. 2B is a diagram of four example training images that are generated in 110 of the method 100 using the model trained in 108. As noted, these training images can then be used for training the OCR machine learning model.

The described method 100 provides a way to easily generate large numbers of images that mimic handwritten text including non-alphanumeric characters in desired character sequence formats, which can then be used to train an OCR machine learning model. The resultantly trained OCR machine learning model will likely have improved accuracy when applied to images of actual such handwritten as compared to if it were trained with training images of more general handwritten text.

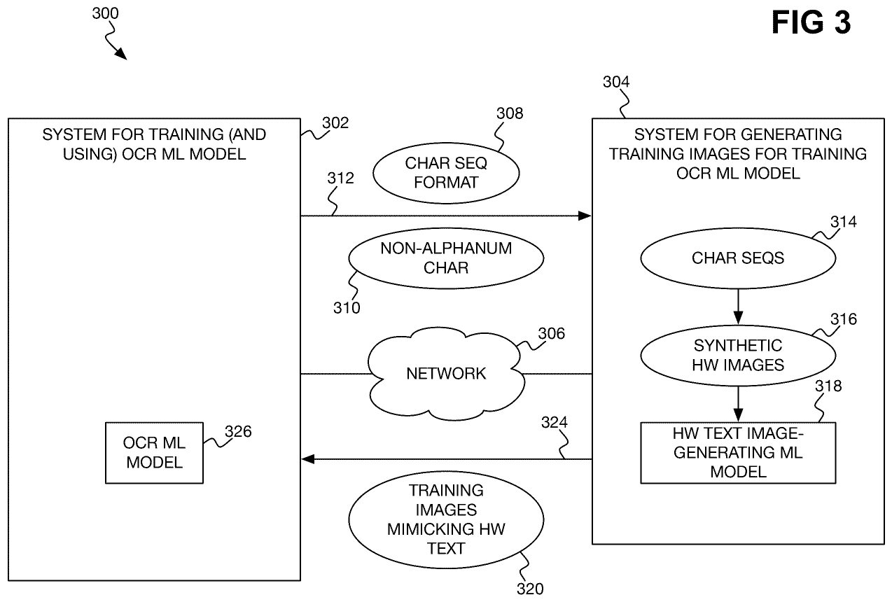

FIG. 3 shows an example environment 300 in relation to which the method 100 can be implemented. The environment 300 includes system 302 and 304 that are communicatively connected to one another over a network 306. Each of the systems 302 and 304 may include one or multiple computing devices, such as desktop, laptop, notebook, or server computers. The network 306 may be or include the Internet. It is also noted that the systems 302 and 304 may be implemented as a single system, such as a single computing device, and the systems 302 and 304 may each be implemented as more than one sub-system (i.e., as more than one system) as well.

System 302 is for at least training an OCR machine learning model 326. The system 302 may also be for using the trained model 326, and/or a different system may use the model 326 trained by the system 302, either by itself or by querying the system 302. The system 304 is for generating training images 320 mimicking handwritten text that the system 302 then uses for training the OCR machine learning model 326.

Per arrow 312, the system 302 provides specification of a character sequence format 308, including one or more non-alphanumeric characters 310, for the handwritten text that the training images 320 mimic. The system 304 receives the specified format 308 and characters 310 from the system 302 over the network 306. The system 304 generates character sequences 314 in the specified format 308 with the specified non-alphanumeric characters 310, and then generates synthetic handwritten images 316 for each sequence 314.

The system 304 thereafter trains a handwritten text image generating machine learning model 318 using the generated images 316, and runs the trained model 318 to generate the training images 320 that mimic the handwritten text in the character sequence format 308 and including the non-alphanumeric characters 310. The system 304 returns the training images 320 to the system 302, per arrow 324, which can then train and the OCR model 326 based on the images 320.

The system 304 may be operated by an entity, such as an enterprise or other organization. The system 304 may provide a web service, such as in the form of an application programming interface (API), over the network 306 to other entities. These other entities may be customers of the entity operating the system 304. An end user of such a customer can thus operate the system 302 to access the web service provided by the system 304 to request and receive training images 320 that mimic handwritten text in a character sequence format 308 and including non-alphanumeric characters that the user wants to tailor the OCR model 322 to. The system 302 may be considered a user computing device in this respect.

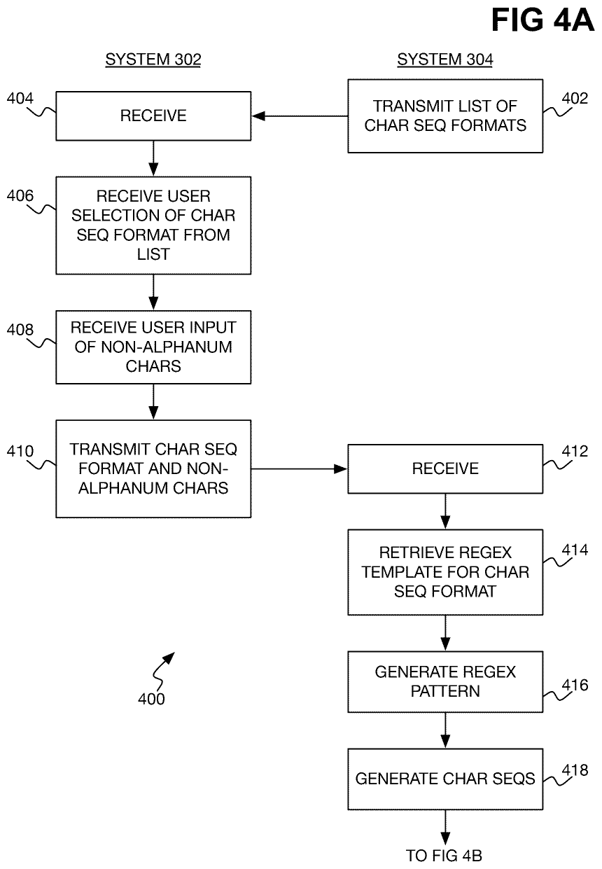

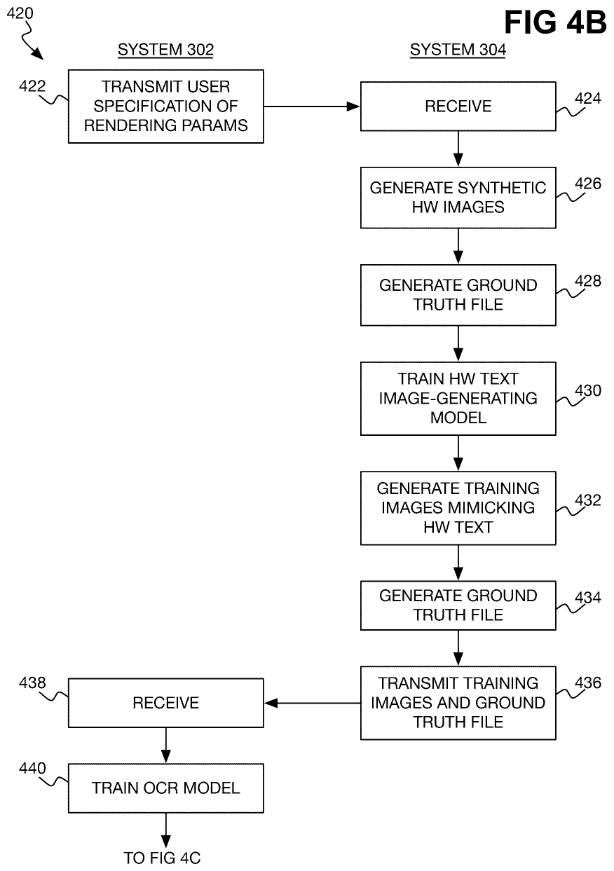

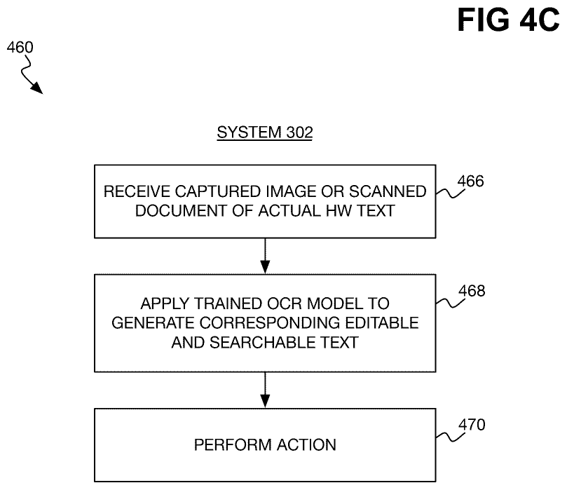

FIGS. 4A, 4B, and 4C show an example method 400, 420, and 460 for generating training images 320 mimicking handwritten text in the character sequence format 308 including the non-alphanumeric characters 310, and then for training and using an OCR machine learning model 326, within the environment 300. The system 302 performs the parts of the method 400 and 420 in the left-hand columns of FIGS. 4A and 4B, and the system 304 performs the parts in the right-hand columns. The system 302 performs the method 460 of FIG. 4C. Each of the systems 302 and 304 may, for instance, include a processor and a computer-readable data storage medium storing program code executable by the processor to perform its respective method parts.

Referring to FIG. 4A, the system 304 can transmits to the system 302 over the network 306 a list of different predetermined character sequence formats (402). The list may include different email address, currency, number, and/or date formats. The system 302 thus receives the list of predetermined formats (404). The system 302 can receive user specification of a desired character sequence format 308 from the list (406), as well as user input of non-alphanumeric characters 310 to use when generating character sequences in the specified format 308 (408).

The system 302 transmits the specified format 308 and characters 310 to the system 304 over the network 306 (310). The system 304 therefore receives the character sequence format 308 and non-alphanumeric characters 310 (412). The system 304 can retrieve a regular expression template for the character sequence format 308 (414). For instance, the template may be retrieved from a database of predetermined such templates for the predetermined character sequence formats. The system can then generate a regular expression pattern by modifying the template in accordance with the specified non-alphanumeric characters 310 (416).

The system 304 can generate the character sequences 314 in the specified format 308 with the specified non-alphanumeric characters 310 using this generated regular expression (418), as has been described. For example, the format 308 may be a date format in which the month is expressed by two digits, the day is expressed by two digits, and the year is expressed by four digits. The date format may specify that the month, day, and year are to appear in that order, as well as the non-alphanumeric character that is to separate them, such as a dash or a slash. The regular expression template may include the sequences “^{∧}(0[1-9]|[12][0-9]|3[01])”, “(0[1-9]|1[0-2])”, and “(\d{4})$”.

In this case, if the non-alphanumeric character “\” is specified to separate the month, day, and year, the regular expression generated based on the template is “^{∧}(0[1-9]|[12][0-9]|3[01])/(0[1-9]|1[0-2])/(\d{4})$”. That is, the three sequences in the regular expression template are separated from one another by slashes to modify the template to generate the regular expression pattern. Other types of regular expression templates that can be modified in other ways to generate the regular expression patterns may instead be employed.

Referring to FIG. 4B, the system 302 may also transmit user specification of rendering parameters over the network 306 to the system 304 (422), which thus receives them (424). The system 304 generates the synthetic handwritten images 316 for each character sequence 314 based on the rendering parameters (426). The system 304 may also generate a ground truth file specifying the actual sequence 314 to which each image 316 corresponds (428) if the handwritten text image-generating machine learning model 318 is trained in a supervised or partially supervised manner.

The system 304 then trains the handwritten text image-generating machine learning model 318 using the synthetic handwritten images 316 or both the images 316 and the ground truth file (430). The system 304 generates training images 320 mimicking handwritten text including the non-alphanumeric characters 310 in the character sequence format 308 by using the trained model 318. The system 304 also generates a ground truth file specifying the actual character sequence to which each training image 320 corresponds (436).

The ground truth file that is generated in 434 is not to be confused with the ground truth file that may have been generated in 428 earlier. The former is for training the handwritten text image-generating model 318 by the system 304, whereas the latter is for training the OCR model 326 by the system 302. The system 304 transmits the training images 320 and the ground truth file for the training images 320 over the network 306 to the system 302 (436). The system 302 receives the training images 320 and ground truth file (438), and uses them to train the OCR model 326 (440).

Referring to FIG. 4C, the system 302—or another system that may interact with the system 302—may then use the trained OCR machine learning model 326. Specifically, a captured image or a scanned document of actual handwritten text is received (466). For example, an image of text that has actually been handwritten by a person may be captured using a smartphone, a digital camera, or another type of device. As another example, a paper document including such actual handwritten text may be scanned using a sheetfed or flatbed standalone scanner or other device has scanning capability, such as a multifunction device that also has printing functionality.

The trained OCR machine learning model is applied to the captured image or scanned document to generate corresponding editable and searchable text (468). An action may then be performed based on the handwritten text that has been recognized in the image or document using the OCR model (470). As a concrete example, the handwritten text may specify instructions for controlling a device such as a robot or reconfiguring a device such as a computer. Improving the accuracy of the OCR model to recognize the instructions thus provides for a practical application in the control of a robot or the reconfiguration of a computer.

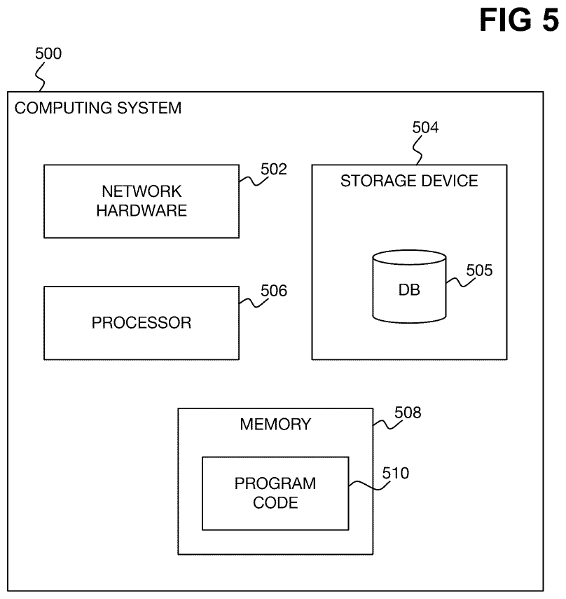

FIG. 5 shows an example computing system 500. Each of the systems 302 and 304 of FIG. 3 can be implemented as an instance of the system 500. Each instance of the computing system 500 can be or include one or more computing devices, such as desktop, laptop, notebook, and server computing devices, as well as other computing devices like smartphones, tablet computing devices, and so on. The computing system 500 includes at least network hardware 502, a storage device 504, a processor 506, and memory 508.

The network hardware 502 may also be referred to as a network circuit, and permits the system 500 to connect to another computing device or system over the network 306. The storage device 504 may be a non-volatile computer-readable data storage medium, such as an SSD, HDD, or flash memory. In the case in which the system 500 implements the system 302, the storage device 504 may store the OCR machine learning model 326. In the case in which the system 500 implements the system 304, the storage device 504 can store a database of predetermined regular expression templates for predetermined character sequence formats.

The memory 508 may be a volatile or non-volatile computer-readable data storage medium, and stores program code 510. In the case in which the computing system 500 implements the system 302, execution of the program code 510 by the processor 506 results in performance of the parts of the method 400 and 420 in the left-hand columns of FIGS. 4A and 4B, and can also result in performance of the method 560 of FIG. 4C. In the case in which the computing system 500 implements the system 304, execution of the program code 510 by the processor 506 results in performance of the method parts in the right-hand columns of FIGS. 4A and 4B.

Techniques have been described for generating training images for OCR machine learning models. The training images mimic handwritten text in a specified character sequence format including specified non-alphanumeric characters. Training an OCR machine learning model using such training images 320 improves OCR of captured images and scanned documents including actual handwritten text in the specified format and including the specified characters. The techniques described herein therefore provide for a technical improvement in the technology of machine learning, as well as in OCR technology.

We claim:

1. A method for generating training images mimicking handwritten text including one or more non-alphanumeric characters, the training images used at least for training an optical character recognition (OCR) machine learning model, the method comprising:
specifying, by a processor, a character sequence format and the non-alphanumeric characters;
generating, by the processor, a plurality of character sequences in the specified character sequence format with the specified non-alphanumeric characters using a regular expression pattern for the specified character sequence format;
generating, by the processor, synthetic handwritten images for each character sequence;
training, by the processor, a handwritten text image-generating machine learning model for generating the training images, the handwritten text image-generating machine learning model trained using at least the generated synthetic handwritten images; and
generating, by the processor, the training images mimicking the handwritten text including the non-alphanumeric characters using the trained handwritten text image-generating machine learning model.

2. The method of claim 1, further comprising:
training, by the processor, the OCR machine learning model using the generated training images.

3. The method of claim 2, further comprising:
applying, by the processor, the trained OCR machine learning model to a captured image or scanned document of actual handwritten text to generate editable and searchable text corresponding to the actual handwritten text in the captured image or scanned document.

4. The method of claim 2, wherein training the OCR machine learning model using the training images generated using the handwritten text image-generating machine model that is trained using at least the generated synthetic handwritten images improves OCR of scanned or captured images of documents of actual handwritten text using the OCR machine learning model.

5. The method of claim 1, wherein specifying the character sequence format and the non-alphanumeric characters comprises:
receiving user selection of the character sequence format from a plurality of predetermined character sequence formats.

6. The method of claim 5, wherein specifying the character sequence format and the non-alphanumeric characters further comprises:
receiving user input of the non-alphanumeric characters to use in the regular expression pattern when generating the character sequences in the specified character sequence format.

7. The method of claim 1, further comprising:
retrieving, by the processor, a predetermined regular expression template for the specified character sequence format; and
generating, by the processor, the regular expression pattern to use to generate the character sequences, by modifying the predetermined regular expression template in accordance with the specified non-alphanumeric characters.

8. The method of claim 7, wherein generating the character sequences in the specified character sequence format with the specified non-alphanumeric characters comprises:
using a regular expression sample generator to the generate the character sequences based on the regular expression pattern.

9. The method of claim 1, further comprising:
receiving, by the processor, user specification of a plurality of rendering parameters comprising:
a font parameter specifying one or more handwriting fonts by font type, font style, and/or font size;
a background parameter specifying one or more image backgrounds; and
a filter parameter specifying one or more filters,
wherein the synthetic handwritten images for each character sequence are generated according to a plurality of font-background-filter combinations that each include one of the handwriting fonts, one of the image backgrounds, and one of the filters.

10. The method of claim 1, wherein the handwritten text image-generating machine learning model is trained in an unsupervised learning manner without a ground truth file specifying the character sequence to which each synthetic handwritten image corresponds.

11. The method of claim 1, further comprising:
generating a ground truth file specifying the character sequence to which each synthetic handwritten image corresponds,
wherein the handwritten text image-generating machine learning model is trained in a supervised learning manner using the ground truth file in addition to the synthetic handwritten images.

12. A non-transitory computer-readable data storage medium storing program code executable by a computing device to perform processing for generating training images mimicking handwritten text including one or more non-alphanumeric characters, the training images used at least for training an optical character recognition (OCR) machine learning model, the processing comprising:
receiving, from a user computing device over a network, user specification of a character sequence format and the non-alphanumeric characters;
generating a plurality of character sequences in the character sequence format with the non-alphanumeric characters using a regular expression pattern for the character sequence format;
generating synthetic handwritten images for each character sequence;
training a handwritten text image-generating machine learning model for generating the training images, the handwritten text image-generating machine learning model trained using at least the generated synthetic handwritten images;
generating the training images mimicking the handwritten text including the non-alphanumeric characters using the trained handwritten text image-generating machine learning model; and
transmitting, to the user computing device over the network, the training images that have been generated which mimic the handwritten text including the non-alphanumeric characters and which are used for training the OCR machine learning model.

13. The non-transitory computer-readable data storage medium of claim 12, wherein the processing further comprises:
retrieving, from a database, a predetermined regular expression template for the character sequence format; and
generating the regular expression pattern to use to generate the character sequences, by modifying the predetermined regular expression template in accordance with the non-alphanumeric characters.

14. The non-transitory computer-readable data storage medium of claim of claim 13, wherein generating the character sequences in the character sequence format with the non-alphanumeric characters comprises:
using a regular expression sample generator to the generate the character sequences based on the regular expression pattern.

15. The non-transitory computer-readable data storage medium of claim 12, wherein the processing further comprises:
receiving, from the user computing device over the network, specification of a plurality of rendering parameters comprising:
a font parameter specifying one or more handwriting fonts by font type, font style, and/or font size;
a background parameter specifying one or more image backgrounds; and
a filter parameter specifying one or more filters,
wherein the synthetic handwritten images for each character sequence are generated according to a plurality of font-background-filter combinations that each include one of the handwriting fonts, one of the image backgrounds, and one of the filters.

16. The non-transitory computer-readable data storage medium of claim 12, wherein the processing further comprises:
generating a ground truth file specifying the handwritten text to which each training images corresponds; and
transmitting the ground truth file to the user computing device over the network to use with the training images when training the OCR machine learning model.

17. The non-transitory computer-readable data storage medium of claim 16, training the OCR machine learning model using the ground truth file and the training images improves OCR of scanned or captured images of documents of actual handwritten text using the OCR machine learning model.

18. A computing system for generating training images mimicking handwritten text including one or more non-alphanumeric characters, the training images used at least for training an optical character recognition (OCR) machine learning model, the computing system comprising:
network hardware to communicatively connect to a user computing device over a network;
a storage device storing a database of a plurality of predetermined regular expression templates for a plurality of different character sequence formats;
a processor; and
a memory storing program code executable by the processor to perform processing comprising:
receiving, from the user computing device over the network, user specification of a character sequence format from the plurality of different character sequence formats;
receiving, from the user computing device over the network, user specification of the non-alphanumeric characters;
retrieving, from the database, the predetermined regular expression template for the character sequence format; and
generating a regular expression pattern for the character sequence format, by modifying the retrieved predetermined regular expression template in accordance with the non-alphanumeric characters;
generating a plurality of character sequences in the character sequence format with the non-alphanumeric characters, using the generated regular expression pattern;
generating synthetic handwritten images for each character sequence;
training a handwritten text image-generating machine learning model for generating the training images, the handwritten text image-generating machine learning model trained using at least the generated synthetic handwritten images;
generating the training images mimicking the handwritten text including the non-alphanumeric characters using the trained handwritten text image-generating machine learning model; and
transmitting, to the user computing device over the network, the training images that have been generated which mimic the handwritten text including the non-alphanumeric characters and which are used for training the OCR machine learning model.

19. The computing system of claim 18, wherein the processing further comprises:
receiving, from the user computing device over the network, specification of a plurality of rendering parameters comprising:
a font parameter specifying one or more handwriting fonts by font type, font style, and/or font size;
a background parameter specifying one or more image backgrounds; and
a filter parameter specifying one or more filters,
wherein the synthetic handwritten images for each character sequence are generated according to a plurality of font-background-filter combinations that each include one of the handwriting fonts, one of the image backgrounds, and one of the filters.

20. The computing system of claim 18, wherein the processing further comprises:
generating a ground truth file specifying the character sequence to which each training image corresponds; and
transmitting the ground truth file to the user computing device over the network to use with the training images when training the OCR machine learning model.
